(19) United States
(12) Patent Application Publication
(10) Pub. No.: US 2024/0403773 A1
(43) Pub. Date: Dec. 5, 2024

(54) AI-ASSISTED PRODUCT INNOVATION AND DEVELOPMENT PLATFORM AND METHOD

(71) Applicant: Stitch Technology Exploration Corporation, Basking Ridge, NJ (US)

(72) Inventors: Raghuram Kaushik Pillalamarri, Basking Ridge, NJ (US); Jan-Anders Mansson, West Lafayette, IN (US)

(21) Appl. No.: 18/679,214

(22) Filed: May 30, 2024

Related U.S. Application Data
(60) Provisional application No. 63/471,637, filed on Jun. 7, 2023.
(60) Provisional application No. 63/471,678, filed on Jun. 7, 2023.
(60) Provisional application No. 63/470,323, filed on Jun. 1, 2023.

(51) Int. Cl. G06Q 10/0637

(52) U.S. Cl. CPC G06Q 10/0637

(57) ABSTRACT

A computer-implemented AI-assisted product innovation, development, and launch platform includes a registration module that registers a plurality of users who may be product producers, product manufacturers, product designers, engineers, materials scientists, technology providers, prototype builders, researchers, and validation labs. The platform is configured to receive requests for product specifications, search and identify expertise and resources among the registered users and external expertise and resources needed to create the requested product, and to formulate a launch plan for the requested product and enable collaboration among the identified expertise and resources. The platform further manages collaboration among the identified expertise and resources, and provides comprehensive project management along the entire product design, development, and launch path.

### RELATED APPLICATION

This patent application claims the benefit of U.S. Provisional Patent Application No. 63/470,323 filed on Jun. 1, 2023, and Nos. 63/471,637 and 63/471,678, both filed on Jun. 7, 2023, all of the foregoing being incorporated herein by reference.

### FIELD

The present disclosure relates generally to a platform and a method for applying artificial intelligence (AI) to dynamically “stitch” together tailored products, services, and/or technologies to create and implement product innovations for rapid market entry and deployment, particularly in high-velocity industries such as sports, electronics, and apparel.

### BACKGROUND

Companies designing and innovating new products often face a myriad of issues and challenges throughout their product design and time-to-market cycles. Initial stages of design can be fraught with conceptual challenges, including defining clear objectives and aligning the design with market needs and technological feasibility. As the product moves into the testing phase, unforeseen technical problems and design flaws may emerge, requiring significant iterations and adjustments. Beta testing with customers introduces another layer of complexity, as real-world use can reveal unanticipated issues and generate diverse user feedback. Balancing this feedback while maintaining the original vision and functionality of the product can be particularly challenging. Furthermore, time constraints and budget limitations often pressure companies to expedite the tweaking and finalization processes, potentially compromising thorough testing and refinement. These cycles demand continuous collaboration, effective communication, and agile problem-solving to navigate successfully and deliver a high-quality product to market.

### BRIEF DESCRIPTION OF THE DRAWINGS

FIG. 1 is a simplified illustration of the innovative concept behind the AI-assisted product innovation and development platform and method described herein according to the teachings of the present disclosure;

FIG. 2 is a simplified diagram illustrating the main stages of the AI-assisted product innovation and development sequence described herein according to the teachings of the present disclosure;

FIG. 3 is a simplified workflow diagram of the AI-assisted product innovation and development platform and method described herein according to the teachings of the present disclosure;

FIG. 4 is a simplified system architecture diagram of the AI-assisted product innovation and development platform and method described herein according to the teachings of the present disclosure;

FIG. 5 is a more detailed workflow diagram of the AI-assisted product innovation and development platform and method described herein according to the teachings of the present disclosure;

FIGS. 6 and 7 are simplified flowcharts of the AI-assisted product innovation and development platform and method described herein according to the teachings of the present disclosure; and

FIG. 8 is a simplified block diagram of the AI-assisted product innovation and development platform and method described herein and its operating environment according to the teachings of the present disclosure.

### DETAILED DESCRIPTION

The problem addressed by the system and method described in the present disclosure is the significant time-to-market hurdles faced in certain industries, such as the sporting goods industry. The sporting goods industry demands rapid innovation to remain competitive, yet short technology cycles strain and limit in-house resources for sporting goods producers that create products, and sports organizers that create compelling experiences for fans through innovative technologies. Short technology cycle refers to the rapid pace at which technology evolves and becomes outdated. In high-velocity industries such as sports engineering/tech, electronics, apparel, and pharmaceuticals, companies face significant pressure to innovate continually. New advancements and innovations are introduced frequently, necessitating constant updates to products and services. This rapid turnover can strain in-house resources, as companies must continuously invest in research and development to keep up with the latest technological trends and remain competitive in the market. The challenge is compounded by the difficulty in accessing external expertise and technologies, which are critical for maintaining a competitive edge in such a fast-paced environment. This often results in delays or market failures for new products and experiences. Additionally, there is a challenge of limited access to external expertise and technologies that are required to create compelling products and experiences. Despite the existence of vast market resources with innovation opportunities, accessing these expert technology providers proves difficult due to the lack of convenient methods and tools. Consequently, there are missed opportunities for innovation and advancement in the fast-paced sporting goods industry.

Existing technology solutions fall short in addressing these challenges adequately. While some platforms focus on matching users with experts, they primarily cater to searching for coaches, facilities, and other resources for training or recreational purposes, lacking a specific focus on technology innovation or product launch. These solutions either provide information on available experts or attempt one-to-one matchmaking, but they do not facilitate the gathering of all resources required for technology innovation or product launch. Moreover, they lack the capability of “expertly matching” and “seamlessly stitching” custom technology innovation or product launch solutions. Furthermore, they lack the capability to orchestrate and guarantee successful market launches through a “supported path.” It should be noted that although the present disclosure is focused on the sporting goods space, the platform and methodology described herein are equally applicable to other industries.

To overcome these limitations, the AI-assisted system and method (also collectively referred to as the platform 100) described herein address the aforementioned challenges and introduce a digital marketplace that empowers sports innovation with a rapid and fully-supported design-to-market path. The platform 100 facilitates the “expertly matching” of “sporting goods producers” and “organizers” (also called the demand side of the marketplace) with “sports technology providers” (the supply side of the marketplace), “seamlessly stitches” tailored market solutions, and enables the rapid launch of products to the market. The term “expertly matching” refers to methodologies that use advanced algorithms and artificial intelligence to analyze the specific needs of a product or innovation request to search for and identify the best-suited experts and resources from both internal and external sources. The term “seamlessly stitching” refers to the platform's ability to bring together different elements-such as experts, technologies, and processes-into a unified, well-coordinated team. This integration ensures smooth collaboration and communication among all parties involved, minimizing disruptions and inefficiencies. This ensures that the selected experts and resources have the relevant skills, knowledge, and experience to contribute effectively to the project's success. The goal is to create a streamlined workflow that facilitates the rapid and effective development and launch of new products. This process provides a “fully-supported path” that includes creating project plans, business plans, contracts, budget requirements, go-to-market plans, and other necessary artifacts. The “fully-supported path” means a guided and structured process that ensures all necessary steps and resources are in place for the successful execution and launch of a product or innovation. This includes continuous support, monitoring, and provision of tools to enhance efficiency, productivity, and risk management. The fully-supported path involves providing a clear roadmap for the product development and launch process. This includes offering tools, resources, and ongoing assistance to navigate each stage of innovation. The platform orchestrates the entire process to save time, accelerate task execution, and minimize risks by identifying potential issues in advance and addressing them proactively. The fully-supported path also encompasses creating and integrating various plans and artifacts, conducting comprehensive research and analysis internally and externally, and automating workflows such as go-to-market plans and contracts. By fostering collaboration, improving productivity, and nurturing the team, the platform ensures that all activities are on track and that the product reaches the market successfully and efficiently. Additionally, the platform adopts a holistic approach by continuously analyzing existing work done by the teams to ensure no aspects are overlooked. This holistic approach includes cross-checking plans with external competitive works and market trends, mitigating the risk of human error and negligence, and ensuring a thorough and comprehensive development process. The platform enables key processes and establishes a collaborative environment and workflow for all stakeholders, both internal and external to the company, to work together to deliver the project/product innovation.

By streamlining the innovation process and providing access to a network of expertise and resources through a holistic approach, the platform aims to revolutionize the sporting goods industry and drive successful product launches.

The AI-assisted product innovation and development platform 100 (also referred to as a product innovation marketplace platform) is a technology platform that enables a marketplace for supply side and demand side to cooperatively work together and ignite innovation in various industries. The platform 100 initially targets the sports-tech industry and enables a product innovation marketplace platform that empowers seamless exploration of cutting-edge sports technology and resources. It identifies and matches sporting goods brands and organizers (sport goods producers) with sports technology providers to drive collaboration, stitches sport innovation together to create new and exciting products and services and accelerates the launch of differentiated sport innovation for rapid market entry. The platform uses artificial intelligence to dynamically stitch tailored solutions for launch and is a one-stop-shop for easier access to information, technology providers, and resources. The resources can be any person, thing, or entity that can contribute to the project, such as data, software, hardware, tools, equipment, machines, bots, and AI solutions. The platform is a comprehensive platform that not only provides access to resources but also offers a complete suite of tools and services for identifying, matching, and integrating expertise and technologies. This includes orchestrating teamwork and workflows, providing a supported path, creating artifacts based on analysis and research, increasing productivity, accelerating launch, identifying and mitigating risks, and ensuring the success of product innovations and launches. This holistic approach ensures that all necessary steps and resources are in place for the successful execution and launch of product innovations.

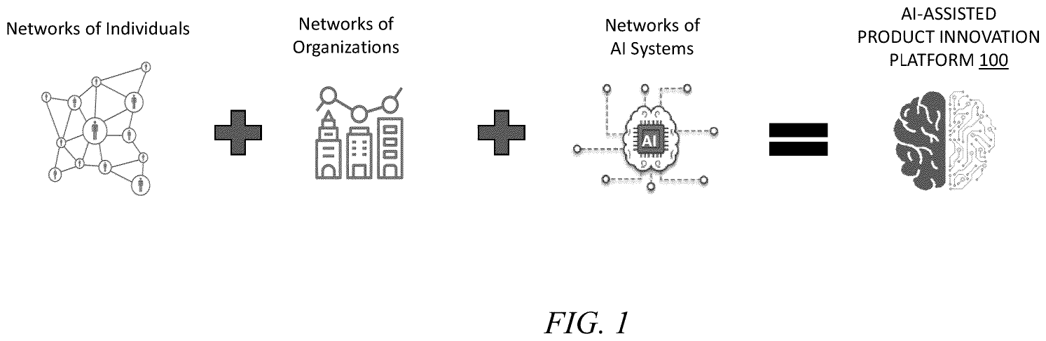

As shown in FIG. 1, the AI-assisted product innovation and development platform 100 stitches together networks of individuals, organizations, and AI systems to enable a product innovation marketplace platform where these entities can work collaboratively to achieve product innovation, implementation, and launch in a rapid and efficient fashion. The platform 100 fulfills a one-stop-shop concept via human+AI collective intelligence and collaboration and bring together demand side (producers and organizers) and supply side (technology providers) entities. The demand side entities include sporting goods companies (existing and aspirational), organizers (e.g., International Olympic Committee (IOC), National Collegiate Athletic Association (NCAA), NFL (National Football League), NBA (National Basketball Association), WNBA (Women's National Basketball Association), MLB (Major League Baseball), NHL (National Hockey League), AHL (American Hockey League), MLS (Major League Soccer), USL (United Soccer League), NWSL (National Women's Soccer League), NASL (North American Soccer League), FIFA (Fédération Internationale de Football Association), PGA (Professional Golfers' Association), LPGA (Ladies Professional Golfers' Association), ATP (Association of Tennis Professionals), WTA (Women's Tennis Association), ITF (International Tennis Federation), USATF (USA Track & Field), USA Cycling, USA Swimming), athletes, sports teams, fans, and sports tech startups. The supply side entities include researchers, engineers, academia, institutions (e.g., Olympics, NCAA, NFL, NBA, WNBA, MLB, NHL, AHL, MLS, USL, NWSL, NASL, FIFA, PGA, LPGA, ATP, WTA, ITF, USATF, USA Cycling, USA Swimming), consultants, labs, and manufacturers.

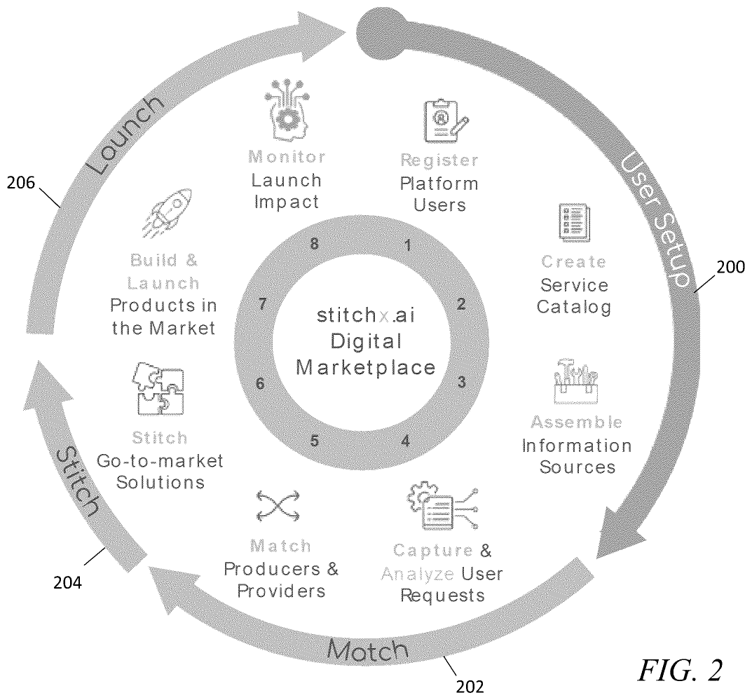

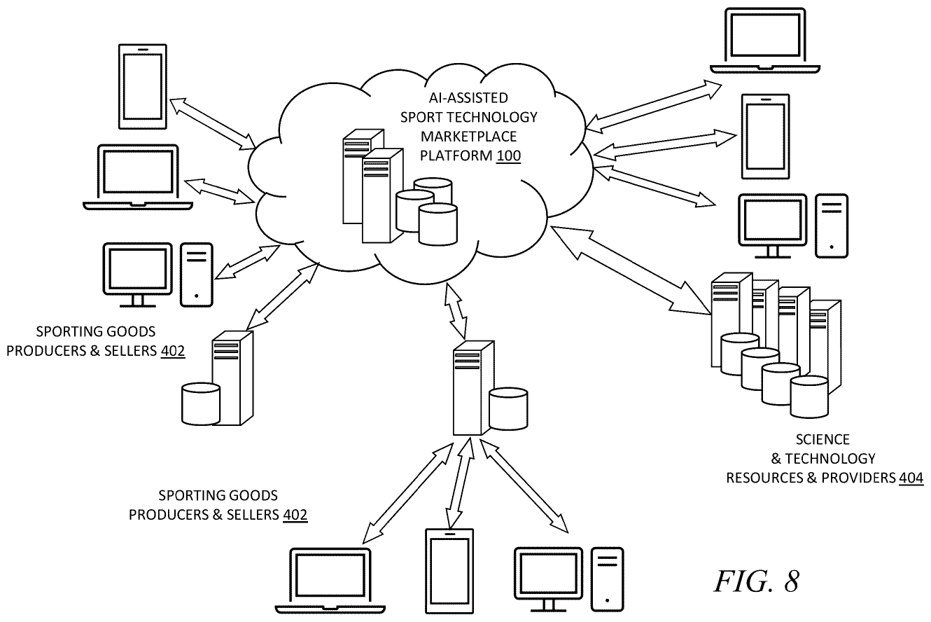

As shown in FIG. 2, the product innovation marketplace platform 100 is a software platform executing in cloud-based servers (see FIG. 8) that uses the latest emerging technologies to enable a range of capabilities such as registering platform users, creating a service catalog, assembling information sources, capturing and analyzing requests from platform users, matching sporting goods brands and sports technology providers, stitching and launching product innovations, driving product development and collaboration for launch, and monitoring launch impact.

In the User Setup Phase 200, users from both the demand and supply sides register on the platform, and all relevant information/data from all the users are collected and stored in one or more databases connected to the platform. A product catalog is created for sports technology providers to showcase their offerings.

In the Match phase 202, users from the demand side express their needs or requests through a natural language user interface (e.g., text, images, verbal, gestures). The platform, using AI technology, captures and analyzes these user needs and requests to understand user intentions, particularly regarding the creation of products. Utilizing natural language processing algorithms, the platform identifies the best match of resources from sports technology providers to satisfy user needs or requests. AI algorithms intelligently optimize the searches for resources, exploring both internal and external connections and networks where relationships have been established. In the Match phase, users select entities and resources that are available to them to work on the project.

In the Stitch phase 204, the platform 100 intelligently stitches together a go-to-market plan for the innovation. The Stitch process involves assessing existing user-created plans, analyzing internal factors such as selected resources, and considering external factors like market dynamics to formulate an optimal plan. In order to stitch a launch innovation solution, several components need to be created and integrated: the team, the business plan, the project plan, market research and customer needs-driven product requirements, the budget, etc. The platform 100 first analyzes all the documents and work done by the user (sporting goods producer or organizer), which means that all this information must be uploaded or fed into the system platform, or be accessible by the platform.

In the Launch phase 206, the platform 100 facilitates collaboration between users and selected resources to execute the innovation go-to-market plan. The platform 100 tracks and monitors progress of tasks within the plans, and offers assistance along the plan execution path to ensure project milestones are reached and progression is on track. The platform 100 is configured to track key performance metrics, gather customer feedback, analyze market trends, identify post-launch issues, and use these insights for continuous improvement.

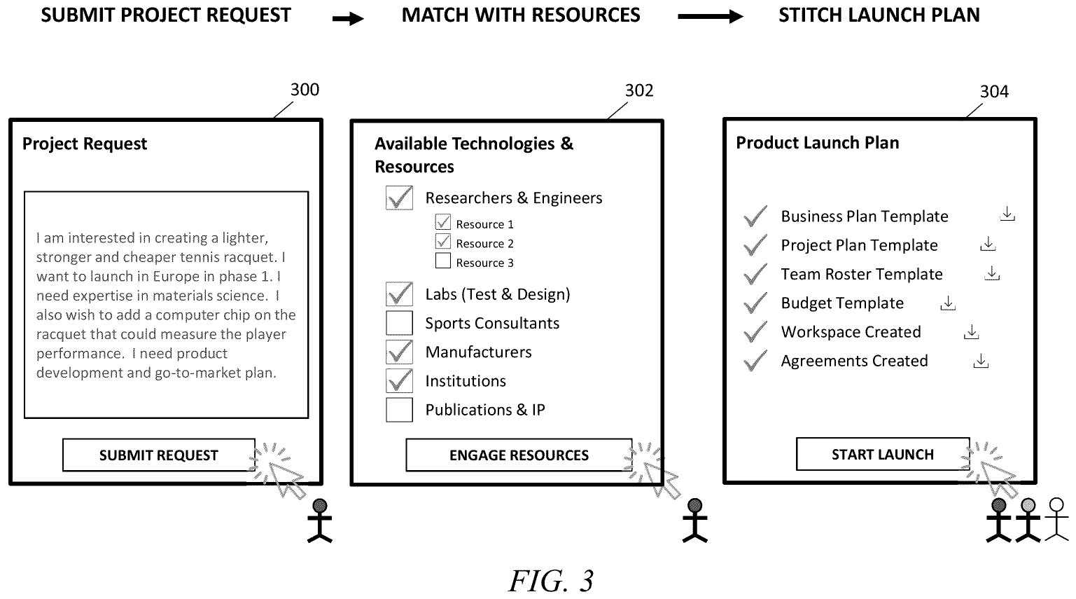

FIG. 3 illustrates how users interact within and on the platform 100. In step 300, a user submits a project request that describes what the user would like to create and take to market. This request may be an input that is in one or combination of data formats, including text, images, graphics, sketches, spoken words, and audio data. In step 302, the user is presented with available technologies and resources along the entire product development path from conception to market. The platform 100 may provide additional information and resources to aid the user in making these selections. The user selects and engages the available resources in step 302. In step 304, the product launch plan is designed and put in place, including facilitating the execution of legal contracts among the parties.

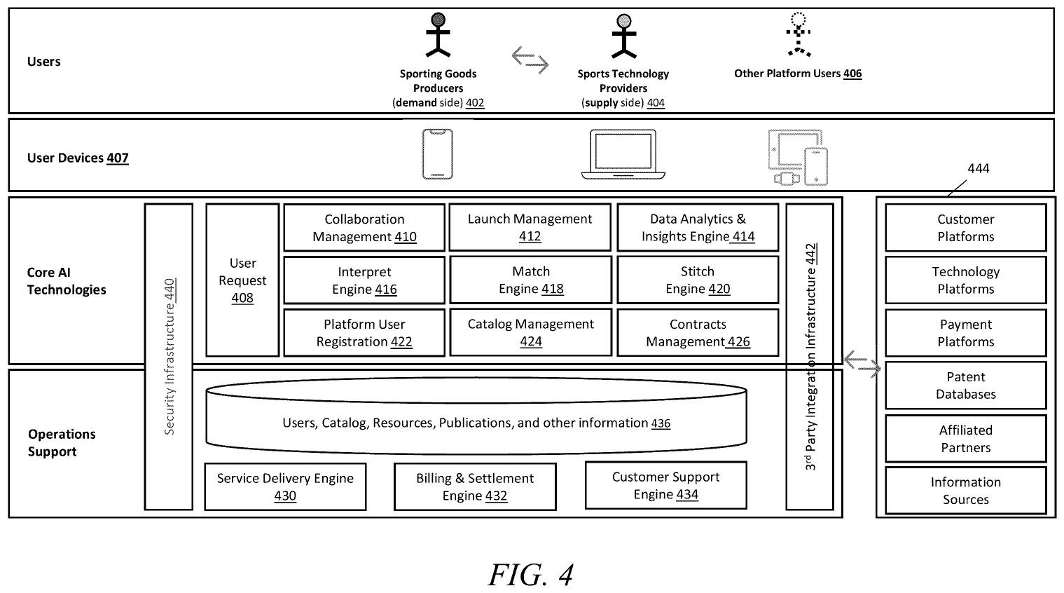

FIG. 4 is a simplified diagram that illustrates an overview of the platform architecture, showcasing the foundational components essential for facilitating the marketplace's match, stitch, and launch processes. It demonstrates the platform's accessibility by demand side users 402, supply side users 404, and other users 406 across various devices 407 and its capability for seamless integration with external platforms. The platform's core technology includes modules that enable the conception to marketplace execution by enabling and performing user request 408, collaboration management 410, launch management 412, data analytics & insights engine 414, interpret engine 416, match engine 418, stitch engine 420, platform user registration 422, catalog management 424, and contracts management 426. The platform user registration 422 enables users from both the demand and supply groups to register onto the platform 100, including querying, receiving, and storing information about their expertise, resources, and needs. The user request module 408 enables demand side users to submit requests for specific products or innovations, outlining their requirements and preferences. The AI-assisted match engine 418 utilizes AI algorithms to search and identify suitable expertise and resources from the registered platform database and external sources, matching them with the submitted requests. The AI-assisted stitch engine 420 orchestrates the assembly of a cohesive team along with the go-to-market plan to facilitate the launch of the product. The AI-assisted collaboration management engine 410 manages the collaboration process between users, ensuring seamless communication and coordination throughout the innovation lifecycle. The AI-assisted launch management engine 412 oversees the product launch process, providing support and monitoring progress to ensure successful market entry.

The platform 100 also includes operations support capabilities, including service delivery engine 430, billing & settlement engine 432, customer support engine 434, and one or more databases 436 that store data related to users, catalogs, resources, publications, etc. A security infrastructure 440 and third-party integration infrastructure 442 span both the core AI technologies and operations support layers of the platform architecture. The third-party integration infrastructure 442 enables seamless connection and communications with entities 444 such as plat forms, technology platforms, payment platforms, patent databases (e.g., United States Patent and Trademark Office databases), affiliated partners, and information sources (e.g. research and academia publications and libraries).

These platform components work together seamlessly to address the preexisting problem of time-to-market hurdles and limited access to external expertise and technologies in the sports innovation industry. By enabling efficient resource matching, collaboration, and launch management, the platform 100 streamlines the innovation process, accelerates product development, and ensures timely market entry. The AI algorithms optimize resource allocation and provide many other critical functionalities, ensuring that users are connected with the most suitable experts and resources to meet their specific needs and have a fully-supported launch plan to reach market launch.

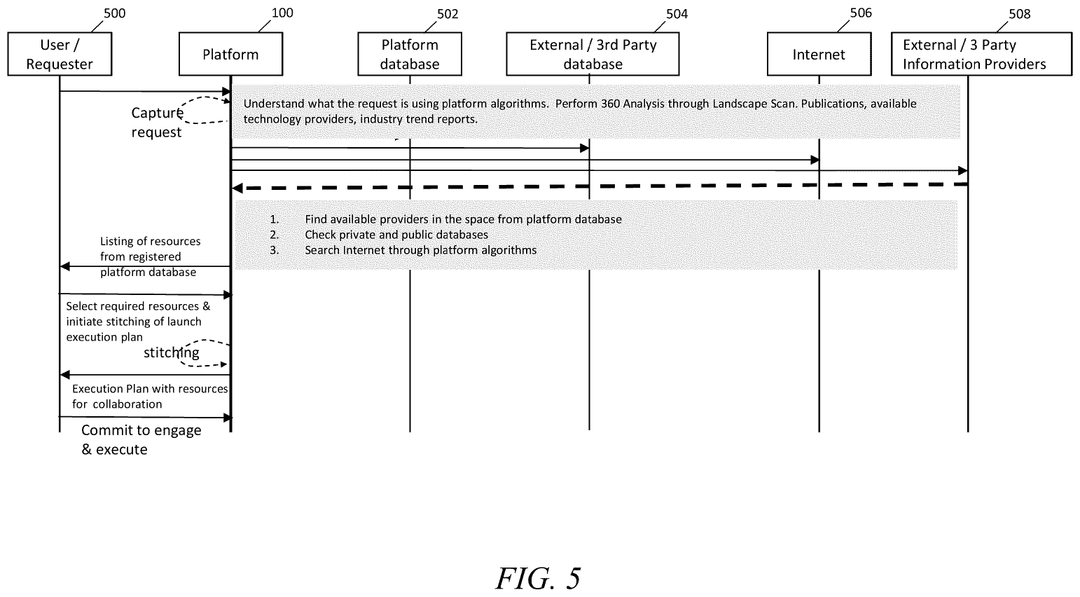

FIG. 5 is a sequence diagram that illustrates the interactions between users 500 and the platform 100. Initially, the user submits a request, which the platform 100 captures and analyzes to comprehend the innovation. Subsequently, the platform 100 conducts a thorough search for resources both internally (in its own databases 502) and externally (external databases 504 and information providers 508 via the Internet 506), generating results. Users 500 can then select the most suitable resources and initiate the stitching of a launch plan. Finally, the platform 100 orchestrates and manages the launch process, facilitating and monitoring collaboration between users and resources.

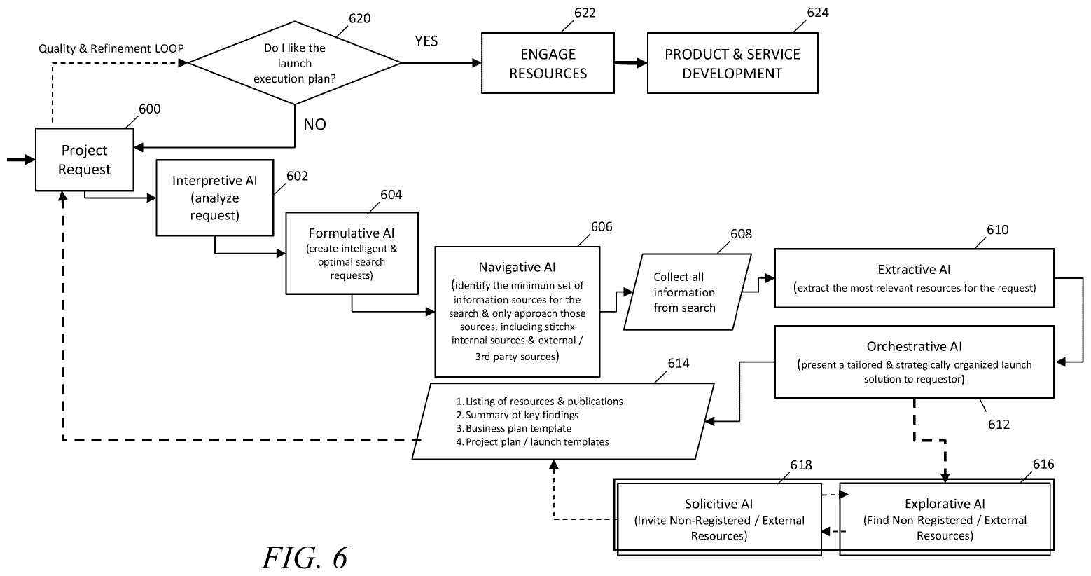

FIG. 6 illustrates how each AI algorithm is triggered and executed in a sequence. The user's request 600 submitted to the platform 100 triggers an interpretive AI module 602 to analyze the user requests, interpreting the underlying innovation or product requirements. The output from interpretive AI 602 is provided to or accessed by a formulative AI module 604, which includes an advanced AI algorithm designed to generate intelligent and optimized search queries based on user inputs or requests. This algorithm formulates search queries in a way that maximizes the likelihood of retrieving relevant and valuable information or resources from various sources. By analyzing the context and requirements of the user's request, formulative AI 604 dynamically generates search queries tailored to specific needs, leading to more accurate and efficient search results. Navigative AI 606 then identifies the minimum set of information sources necessary for conducting searches, including both internal: sources within the platform 100 and external third-party sources. It also streamlines the search process by focusing on relevant sources only. All of the research results are collected (block 608) and stored. An extractive AI module 610 then extracts the most relevant resources from the search results obtained through navigative AI 606, ensuring that only the most suitable resources are presented to the user. An orchestrative AI module 612 is responsible for generating and presenting tailored and strategically organized launch solutions to the users based on their requests. It synthesizes the selected resources into a cohesive and comprehensive launch (concept-to-market) plan 614 and orchestrates the execution process. The launch plan 614 includes a list of relevant and recommended resources and publications, a summary of key findings, pre-completed business plans, project plans, and go-to-market plans with launch templates. These documents are designed to be more than just basic templates; they are pre-populated with substantial content that covers about 80% to 90% of the necessary information. By providing plans that are 80% to 90% complete, the platform significantly reduces the time required for planning. Users do not have to start from scratch, which accelerates the development and launch process by several months. This pre-completion is achieved through advanced AI algorithms that analyze the user's inputs, existing documents, market data, and best practices to generate comprehensive plans tailored to the specific project requirements. The business plans, project plans, and go-to-market plans provided by the platform are not empty templates but are filled with relevant data, insights, and structured information. This includes market analysis, competitive landscape, budget estimates, timelines, risk assessments, and strategic objectives. Advanced AI algorithms analyze various data points such as user inputs, existing plans, market trends, and historical data to pre-complete these documents. This process ensures that the plans are contextually accurate and highly relevant to the specific needs of the project. Although the documents are largely complete, they are designed with room for human intervention. Users can step in to review, correct, and finalize these documents. This ensures that the plans are not only comprehensive but also customized to meet specific nuances and requirements that might not be fully captured by the AI. Once users have made necessary adjustments, they can finalize and approve the documents for use. This collaborative approach ensures that the final plans are thorough, accurate, and ready for implementation. The pre-completed documents take a holistic approach by integrating various aspects of the project, such as resource allocation, risk management, and market strategies. This comprehensive planning ensures that all critical factors are considered and addressed.

If the platform identifies non-registered resources as a valuable resource for the project because these resources were not available within the platform database, then the platform will attempt to explore, identify, and shortlist non-registered resources. An explorative AI module 616 is tasked with finding and shortlisting non-registered or external resources that match the user's needs. It explores various channels and databases to identify potential resources for solicitation. Once potential resources are identified, a solicitive AI module 618 takes the initiative to contact and invite these non-registered or external entities/resources to register and become part of the platform. It facilitates the expansion of the platform's network and resource pool.

Upon presentation of the launch plan, the user may ask the platform iteratively to refine and regenerate the launch plan if the user is not satisfied with the presented plan (block 620). The user may tweak or modify their request so that the platform 100 may better understand the request. If the user likes the presented launch plan, then the user proceeds to engage with the entities and resources in the plan, assisted by the platform 100, and proceed with product design and development to market.

As part of the platform's process depicted in FIG. 6, the platform 100 also employs machine learning techniques to continuously refine and update its dynamic knowledge base or learned model. As the platform 100 acquires new information, it adjusts its various parameters to improve its performance. This process, known as “training” or “fine-tuning,” involves updating the database or model with new data to enhance its accuracy in making predictions, recommendations, and/or decisions. The database or model is a structured representation of the system's knowledge, enabling it to adapt and make informed choices when presented with new input. At every step of the algorithm progression, the system continuously updates its knowledge or model.

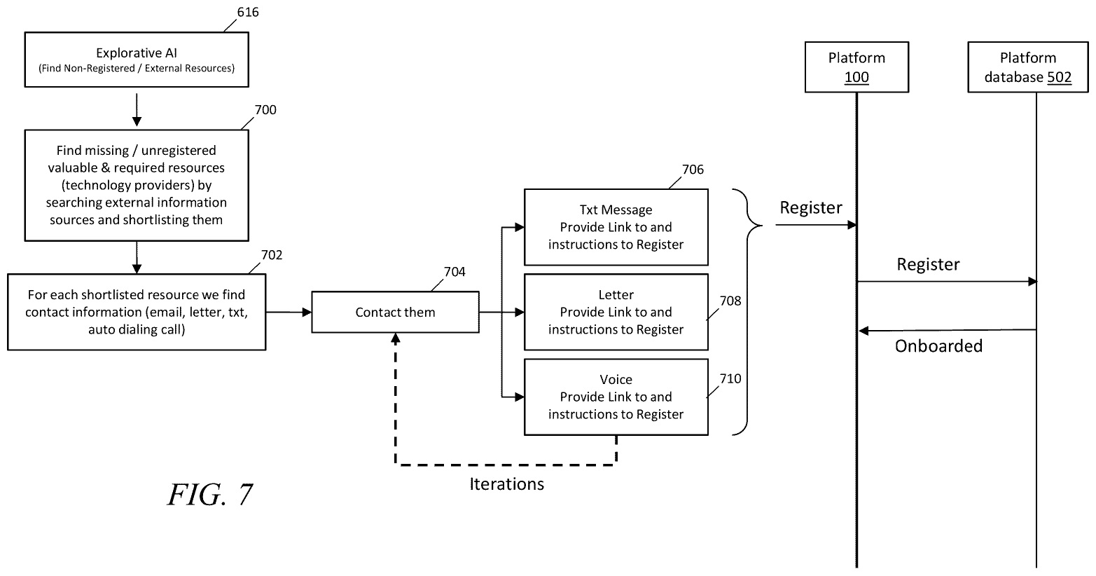

FIG. 7 is a flowchart of the explorative AI module 616 methodology. Explorative AI is tasked with identifying missing or unregistered valuable and required resources, particularly technology providers, by conducting searches across external information sources. Once potential resources are identified, the AI shortlists them based on relevance and suitability for the platform (700). For each shortlisted resource, Explorative AI gathers contact information, including email addresses, postal addresses, phone numbers, and other relevant details (702). Subsequently, the AI initiates contact with these potential resources (704) through various means such as email, physical mail, text messages, and/or automated phone calls, inviting them to register and become part of the platform (706-710). The methods of contact automatically include means for the contacted entity/resource to register with the platform. For example, the method could include a link/URL that the resources can click on, or it could include a Quick Response (QR) codes that can be scanned, etc. When the link is clicked or QR code is scanned, the process of platform registration gets initiated. Once these entities/resources are registered with the platform, they are onboarded to be part of the available resources that can be incorporated within launch plans offered to the users who submit requests.

FIG. 8 is a simplified block diagram of the platform ecosystem. The AI-assisted platform 100 described herein provides a digital innovation infrastructure that empowers rapid and expert-led innovation from concept to the marketplace. The AI-assisted platform 100 facilitates the matching of “sporting goods producers” and “organizers” (also called the demand side of the marketplace) 402 with “sports technology providers” (the supply side of the marketplace) 404, seamlessly stitches tailored market solutions, and enables the rapid launch of products to the market. By streamlining the innovation process and providing access to a network of expertise and resources through a holistic approach, the platform aims to revolutionize the sporting goods industry and drive successful product launches. The platform 100 offers several advantages over existing technologies. Unlike conventional solutions that focus on one-to-one matchmaking or provide generic search results, the platform 100 offers a holistic approach by integrating AI algorithms to analyze user requests, match them with relevant expertise, stitch together tailored launch solutions, and provide a fully-supported mechanism to launch the products in the market successfully. This comprehensive approach ensures that users have access to a diverse network of experts, resources, and execution plans, resulting in faster innovation cycles and successful market launches. By being the first to market, the platform secures a first-mover advantage, positioning itself as the pioneering solution in the industry. Secondly, the platform's one-stop-shop approach saves valuable time and resources by providing all necessary tools and resources in a single platform, thereby streamlining the innovation process. Thirdly, the platform's user-friendly interface and intuitive three-step process-match, stitch, launch-ensure simplicity and ease of use for all stakeholders involved. Finally, the incorporation of AI-assisted intelligence expedites the journey to product launch, enabling rapid innovation and market entry.

An example use cases is a sporting goods company seeking to develop a new line of smart athletic wear. A sporting goods company uses the platform 100 to create a new line of smart athletic wear by connecting with experts in wearable technology and materials science. The platform facilitates collaboration with professional athletes, including those not yet registered, who provide critical feedback on performance and design. Stitchx.ai also delivers pre-completed business and project plans that are 80% to 90% finished, allowing the company to quickly finalize these documents and execute the project efficiently, thus accelerating the product launch by several months.

Another example is a sports event organizer that uses the platform 100 to enhance the fan experience through augmented reality (AR) technology by connecting with AR developers, content creators, and event management experts. The platform solicits feedback from fans, including those not yet registered, to ensure the AR features are engaging and relevant. Stitchx.ai provides pre-completed go-to-market plans that are 80% to 90% complete, enabling the organizer to swiftly finalize and execute the project, ensuring a timely and successful launch of the AR-enhanced event.

The platform 100 also enables demand side users a viable option to outsource expertise and capabilities rather than maintaining in-house personnel and experts for product innovation. The solution offered by the platform 100 is comprehensive and cohesive that can be easily adopted and integrated by the user into its workflow through 3rd party integration infrastructure APIs 442.

The features of the present invention which are believed to be novel are set forth below with particularity in the appended claims. However, modifications, variations, and changes to the exemplary embodiments of the invention described above will be apparent to those skilled in the art, and the described herein thus encompasses such modifications, variations, and changes and are not limited to the specific embodiments described herein.

What is claimed is:

1. A computer-implemented AI-assisted product innovation, development, and launch platform comprising:
a registration module configured to register a plurality of users selected from the group consisting of product producers, product manufacturers, product designers, engineers, materials scientists, technology providers, prototype builders, researchers, and validation labs;
a request module configured to receive, from a user, a request for a product and requisite specifications of the requested product;
an AI-assisted match engine configured to search and identify expertise and resources among the registered users and external expertise and resources needed to create the requested product with the requisite specifications;
an AI-assisted stitch engine configured to formulate a launch plan for the requested product and enable collaboration among the identified expertise and resources;
an AI-assisted collaboration management engine configured to manage collaboration among the identified expertise and resources; and
an AI-assisted launch management engine configured to manage product launch.

2. The platform of claim 1, wherein the registration module is configured to register a plurality of demand side users selected from the group consisting of product producers, brand owners, product sellers, and to register a plurality of supply side users selected from the group consisting of product designers, engineers, materials scientists, technology providers, prototype builders, researchers, and validation labs.

3. The platform of claim 1, wherein the request module is configured to facilitate submission of detailed product specifications.

4. The platform of claim 1, wherein the request module is configured to facilitate submission of detailed product descriptions in a format selected from the group consisting of text, questionnaires, images, diagrams, verbal dialogue, and audio files.

5. The platform of claim 1, wherein the AI-assisted stitch engine is configured to generate the launch plan that includes a business plan, a project plan, a team roster, a budget, and legal contracts.

6. The platform of claim 1, wherein the AI-assisted collaboration management engine is configured to facilitate seamless communication and coordination among the user and the identified expertise and resources.

7. The platform of claim 1, wherein the AI-assisted launch management engine is configured to provide support and monitor progress to ensure hitting project milestones resulting in a successful market launch.

8. The platform of claim 1, wherein the user request module includes natural language processing to process and analyze user submitted product requirements and specifications.

9. The platform of claim 1, further comprises:
an explorative AI module configured to identify and discover external expertise and resources; and
a solicitative AI module configured to invite the external expertise and resources to become registered users.

10. The platform of claim 1 wherein the AI-assisted match engine is configured to identify at least one resource selected from the group consisting of data, software, hardware, tools, equipment, machines, bots, AI technologies and solutions.

11. An AI-assisted product innovation, development, and launch method comprising:
enabling registration of a plurality of users selected from the group consisting of product producers, product manufacturers, product designers, engineers, materials scientists, technology providers, prototype builders, researchers, and validation labs;
enabling submission of requests for a product and requisite specifications of the requested product;
searching and identifying expertise and resources among the registered users and external expertise and resources needed to create the requested product with the requisite specifications, the resources being selected from the group consisting of data, software, hardware, tools, equipment, machines, bots, AI technologies and solutions;
managing collaboration among the identified expertise and resources;
managing product launch; and
monitoring product launch impact.

12. The method of claim 11, wherein enabling registration of a plurality of users comprises receiving information relating to a plurality of demand side users selected from the group consisting of product producers, brand owners, product sellers, and receiving information relating to a plurality of supply side users selected from the group consisting of product designers, engineers, materials scientists, technology providers, prototype builders, researchers, and validation labs.

13. The method of claim 11, wherein enabling submission of requests comprises enabling submission of detailed product specifications.

14. The method of claim 11, wherein enabling submission of requests comprises enabling submission of product specifications in a format selected from the group consisting of text, questionnaires, images, diagrams, verbal dialogue, and audio files.

15. The method of claim 11, further comprising automatically generating and enabling completion, finalization, user-acceptance, and execution of a launch plan that includes a business plan, a project plan, a team roster of identified expertise and resources, a budget, and legal contracts.

16. The method of claim 11, wherein managing collaboration comprises automatically facilitating seamless communication and coordination among the user and the identified expertise and resources.

17. The method of claim 11, wherein managing product launch comprises automatically providing support and monitor progress to ensure hitting project milestones resulting in a successful market launch.

18. The method of claim 11, wherein enabling submission of requests comprises an interpretive AI module using natural language processing to process and analyze user submitted product requirements and specifications.

19. The method of claim 11, wherein searching and identifying expertise and resources comprises:
automatically identifying and discovering external expertise and resources; and
automatically inviting the external expertise and resources to become registered users.

20. The method of claim 11, wherein searching and identifying expertise and resources comprises formulating intelligent and optimal search requests to identify expertise and resources for the requested product.
